(19) United States
(12) Patent Application Publication
(10) Pub. No.: US 2023/0059109 A1
(43) Pub. Date: Feb. 23, 2023

(54) GLASSES-FREE LIGHT-FIELD DISPLAY METHOD BASED ON ASYMMETRIC LIGHT DISTRIBUTION OF PROJECTING BEAM

(71) Applicant: SUN YAT-SEN UNIVERSITY, Guangdong (CN)

(72) Inventors: Lilin LIU, Guangdong (CN); Dongdong TENG, Guangdong (CN)

(73) Assignee: SUN YAT-SEN UNIVERSITY, Guangdong (CN)

(21) Appl. No.: 17/881,629

(22) Filed: Aug. 5, 2022

(30) Foreign Application Priority Data
Aug. 5, 2021 (CN) 202110898730.8
Aug. 26, 2021 (CN) 202110989905.6

(51) Int. Cl. H04N 13/322; H04N 13/363; H04N 13/383

(52) U.S. Cl. CPC H04N 13/322; H04N 13/363; H04N 13/383

(57) ABSTRACT

The present invention relates to the field of three-dimensional display technology, and more specifically, to a glasses-free light-field display method based on asymmetric light distribution of a projecting beam. In the method described in this patent application, beam projected by a pixel or a sub-pixel of a display device is guided to the corresponding pixel-viewing-zone or sub-pixel-viewing-zone of an asymmetric shape, by a corresponding modulation element. Based on these asymmetric pixel-viewing-zones or sub-pixel-viewing-zones, viewing zones for different pixel groups or sub-pixel groups are designed with different arrangement densities along different directions, to realize glasses-free light-field display with a reduced number of viewing zones. Time multiplexing is further introduced for presenting more viewing zones.

### CROSS-REFERENCE TO RELATED APPLICATION

This application claims the priority benefit of China application no. 202110898730.8, filed on Aug. 5, 2021 and China application no. 202110989905.6, filed on Aug. 26, 2021. The entirety of each of the above-mentioned patent applications is hereby incorporated by reference and made a part of this specification.

### TECHNICAL FIELD

The present invention relates to the technical field of three-dimensional image display, and more specifically, to a glasses-free light-field display method based on asymmetric light distribution of a projecting beam.

### BACKGROUND

In the real three-dimensional world, a two-dimensional display is imperfect due to the loss of the third-dimensional depth information. Now, three-dimensional displays attracting more and more attentions. Stereoscopic three-dimensional display technologies based on grating splitting are compatible with existing two-dimensional display devices, and get implemented widely at present. Via a one-dimensional grating, a conventional grating-type three-dimensional display guides beams from different pixel groups to different one-dimensionally-aligned viewing zones. The number of viewing zones that can be presented by stereoscopic three-dimensional display is limited by the spatial bandwidth product of available display devices, to guarantee a moderate display resolution. So, these viewing zones are designed with an interval larger than the pupil diameter Dₚ, to guarantee being able to cover pupils of at least one viewer by these viewing zones of limited number. Thus, a pupil always keeps in a viewing zone, resulting in a one-view-one-eye display. This means that only one two-dimensional image is presented to each pupil of a viewer. In order to see a corresponding two-dimensional image clearly, an eye has to focus on the display device. To activate the depth perception, the viewing directions of a viewer's two eyes converge at the displayed scene, which is often with a distance to the display device. Thus, an inconsistency between the binocular convergence distance and the monocular focal distance exists in conventional stereoscopic 3D displays, which is called Vergence-Accommodation conflict (VAC). The VAC problem triggers visual discomfort, being taken as a bottleneck problem of the three-dimensional display field.

Through projecting at least two two-dimensional images to each pupil of a viewer (multi-view-one-eye display), for a displayed point, at least two passing-through beams will be perceived by a pupil. When the superimposed light distribution at a displayed point is strong enough, the displayed point will drag the focus of a corresponding eye away from the display device, making the VAC problem resolved. This multi-view-one-eye display is also called super multi-view display elsewhere. To project at least two two-dimensional images to each pupil of a viewer via a one-dimensional grating, an interval between adjacent viewing zones must be smaller than the pupil diameter Dₚ, and all such small-interval viewing zones should at least cover a spatial region which contain these two pupils. To fulfill this requirement, a quite large number of small-interval viewing zones are needed, resulting in a low-resolution display. In the United States invention patent with title “Grating based three-dimensional display method for presenting more than one views to each pupil” (U.S. Pat. No. 11,012,673 B2), a kind of asymmetric viewing zones was designed for multi-view-one-eye display with a reduced number of viewing zones. The size of its asymmetric viewing zone was larger than the diameter Dₚ of a pupil along the direction connecting two pupils of a viewer, and smaller than Dₚ along another direction. Such asymmetric viewing zones got implemented by overlapping two kinds of one-dimensional viewing zones, which were respectively called “self-carried viewing zones” and “III-type viewing zones” in U.S. Pat. No. 11,012,673 B2. Among them, the “self-carried viewing zones” got generated by “self-carried optical component/components” affiliated to the display device, and the “III-type viewing zones” were formed by “an one-dimensional grating” adhered to the display device. When the “self-carried optical component/components” was also a one-dimensional grating, a periodic structure of the modulating device might be a structure shown in FIG. 1, which was a composite structure consisting of two cylindrical lenses with different axis directions. In U.S. Pat. No. 11,012,673 B2, the modulating device was a combination of the said “self-carried optical component/components” and said “self-carried optical component/components”. Actually, said “an one-dimensional grating” for generating “III-type viewing zones” made such a structure shown in FIG. 1 corresponding to multiple pixels in U.S. Pat. No. 11,012,673 B2. The structure shown in FIG. 1 can also be replaced by grating structure with a similar modulating function. Obviously, a sub-pixel could also function as a basic display element, although a pixel was exampled as a basic display element in U.S. Pat. No. 11,012,673 B2. Under this condition, at least two two-dimensional images displayed by corresponding sub-pixel groups will be presented to each pupil of the viewer for multi-view-one-eye display.

### SUMMARY OF INVENTION

The purpose of the present invention is to modulate the projection angle and projection direction of the beam from a pixel or a sub-pixel by the corresponding modulating element, with a number of modulating elements corresponding to all the pixels or all the sub-pixels in a one-to-one manner. The modulation of a beam from a pixel or a sub-pixel results in an asymmetric light-distribution zone, functioning as a pixel-viewing-zone or sub-pixel-viewing-zone corresponding to this pixel or sub-pixel. Such an asymmetric light-distribution zone has a large size along the first direction (along the line connecting two pupils of a viewer) and a small size along the second direction (perpendicular or approximately perpendicular to the first direction). Multiple groups of pixels or sub-pixels are designed for presenting at least two two-dimensional images to each pupil of a viewer, for multi-view-one-eye display. Based on the asymmetric light-distribution zones, the viewing zones of different two-dimensional images can be designed with a dense arrangement along the second direction, but a sparse arrangement along the first direction. Such designs result in a reduced number of needed viewing zones, also a reduced number of needed two-dimensional images, relative to the situation that the viewing zones are arranged densely along both of these two directions.

The technical scheme adopted by the present invention is as follows:

a glasses-free light-field display method based on asymmetric light distribution of a projecting beam, wherein:

an optical system employed by the glasses-free light-field display method comprises a display device, a modulating device, and a control device connected to said display device, wherein the display device comprises a plurality of pixels or sub-pixels, a modulating device comprises multiple modulating elements which correspond to the pixels or sub-pixels of the display device in a one-to-one manner;

when each modulating element of the modulating device is assigned to each pixel of the display device in a one-to-one manner, the glasses-free light-field display method comprises following steps:

51: each modulating element modulates a beam outgoing from or incident onto a corresponding pixel, such that the corresponding pixel projects a beam with an asymmetric projection angle, and the asymmetric projection angle results in an asymmetric light-distribution zone of light with an intensity larger than 50% of the maximum value on an observing plane;

wherein, the asymmetric light-distribution zone which is taken as a pixel-viewing-zone of the corresponding pixel has a size larger than Dₚ and smaller than Dₚₘ along a first direction and smaller than Dₚ along a second direction, with Dₚ being a diameter of a pupil and Dₚₘ being a minimum distance between two pupils of a viewer;

S2: each modulating element modulates a projecting direction of a beam projected by a corresponding pixel, in order that all pixel-viewing-zones corresponding to at least two pixel groups intersect with the pupil on the observing plane;

wherein, pixels of each pixel group are arranged throughout the display device, and two pixel-viewing-zones corresponding to two pixels of different groups for a same pupil are set with a non-zero distance along the second direction;

S3: the control device refreshes each pixel by a corresponding light information, which is a projection information of a target object along the beam projected by the pixel;

or, when each modulating element of the modulating device is assigned to each sub-pixel of the display device in a one-to-one manner, the glasses-free light-field display comprises following steps:

SS1: each modulating element modulates a beam outgoing from or incident onto a corresponding sub-pixel, such that the corresponding sub-pixel projects a beam with an asymmetric projection angle, and the asymmetric projection angle results in an asymmetric light-distribution zone of light with an intensity larger than 50% of the maximum value on an observing plane;

wherein, the asymmetric light-distribution zone which is taken as a sub-pixel-viewing-zone of the corresponding sub-pixel has a size larger than Dₚ and smaller than Dₚₘ along a first direction and smaller than Dₚ along a second direction, with Dₚ being the diameter of a pupil and Dₚₘ being the minimum distance between two pupils of a viewer;

SS2: each modulating element modulates a projecting direction of a beam projected by a corresponding sub-pixel, in order that all sub-pixel-viewing-zones corresponding to at least two sub-pixel groups intersect with the pupil on the observing plane;

wherein, sub-pixels of each sub-pixel group are arranged throughout the display device, and two sub-pixel-viewing-zones corresponding to two sub-pixels of different groups for a same pupil are set with a non-zero distance along the second direction;

SS3: the control device refreshes each sub-pixel by a corresponding light information, which is a projection information of a target object along the beam projected by the sub-pixel.

Preferably, when each modulating element of the modulating device is assigned to each pixel of the display device in the one-to-one manner, centers of all pixel-viewing-zones corresponding to a same pixel group overlap and an overlapping region of the sub-pixel-viewing-zones is taken as a viewing zone corresponding to the pixel group;

or when each modulating element of the modulating device is assigned to each sub-pixel of the display device in the one-to-one manner, centers of all sub-pixel-viewing-zones corresponding to a same sub-pixel group overlap and an overlapping region of the sub-pixel-viewing-zones is taken as a viewing zone corresponding to the sub-pixel group.

Preferably, said optical system further comprises a directional backlight structure capable of projecting backlights to said display device along different directions under control of the control device.

Preferably, a backlight provides incident light to a pixel or a sub-pixel at an asymmetric divergence angle or an asymmetric convergence angle which makes the beam projected by the pixel or sub-pixel be with asymmetric light-distribution zone of light with an intensity larger than 50% of the maximum value on an observing plane.

Preferably, said optical system comprises a pupil tracking unit connecting with the control device, to detect spatial positions of a viewer's pupils;

wherein, when each modulating element of the modulating device is assigned to each pixel of the display device in the one-to-one manner, the step S3 further comprises: at a time-point, according to real-time positions of pupils detected by the pupil tracking unit, the control device drives the directional backlight structure to project backlight along the corresponding direction, in order that pixel-viewing-zones corresponding to at least two pixel groups intersect with the pupil on the observing plane;

or, when each modulating element of the modulating device is assigned to each sub-pixel of the display device in the one-to-one manner, the step SS3 further comprises: at a time-point, according to real-time positions of pupils detected by the pupil tracking unit, the control device drives the directional backlight structure to project backlight along the corresponding direction, in order that sub-pixel-viewing-zones corresponding to at least two sub-pixel groups intersect with the pupil on the observing plane.

Preferably, when each modulating element of the modulating device is assigned to each pixel of the display device in the one-to-one manner, the step S3 further comprises: at M time-points of each time-period, the control device drives the directional backlight structure to project backlight along M directions sequentially, for presenting M corresponding pixel-viewing-zones of each pixel, where M≥2;

or, when each modulating element of the modulating device is assigned to each sub-pixel of the display device in the one-to-one manner, the step SS3 further comprises: at M time-points of each time-period, the control device drives the directional backlight structure to project backlight along M directions sequentially, for presenting M corresponding sub-pixel-viewing-zones of each sub-pixel, where M≥2;

wherein, a group of pixels work as M different pixel groups with backlights along different directions;

or, a group of sub-pixels work as M different sub-pixel groups with backlights along different directions.

Preferably, wherein each modulating element of the modulating device is a nanoimprinted grating, or a holographic grating, or a meta surface structure.

Preferably, wherein, when each modulating element of the modulating device is assigned to each pixel of the display device in the one-to-one manner, the pixel-viewing-zones corresponding to different pixels of a same pixel group are misaligned arranged.

Preferably, when each modulating element of the modulating device is assigned to each sub-pixel of the display device in the one-to-one manner, the sub-pixel-viewing-zones corresponding to different sub-pixels of a same sub-pixel group are misaligned arranged.

Preferably, the optical system further comprises a deflecting device which is capable of deflecting the beams outgoing from or incident onto a display device under control of the control device.

Preferably, the optical system comprises a pupil tracking unit connected with the control device, to detect spatial positions of a viewer's pupils;

wherein, when each modulating element of the modulating device is assigned to each pixel of the display device in the one-to-one manner, the step S3 further comprises: at a time-point, according to real-time positions of pupils detected by the pupil tracking unit, the control device drives the deflecting device to deflect the pixel-viewing-zones correspondingly, in order that all pixel-viewing-zones corresponding to at least two pixel groups intersect with the pupil on the observing plane synchronously;

or, when each modulating element of the modulating device is assigned to each sub-pixel of the display device in the one-to-one manner, the step SS3 further comprises: at a time-point, according to the real-time positions of pupils detected by the pupil tracking unit, the control device drives the deflecting device to deflect the sub-pixel-viewing-zones correspondingly, in order that all sub-pixel-viewing-zones corresponding to at least two sub-pixel groups intersect with the pupil on the observing plane synchronously.

Preferably, when each modulating element of the modulating device is assigned to each pixel of the display device in the one-to-one manner, the step S3 further comprises: at M time-points of a time-period, the control device drives the deflecting device to deflect corresponding light-distribution zone of each pixel to M positions sequentially, for presenting M corresponding pixel-viewing-zones of each pixel, where M≥2,

or, when each modulating element of the modulating device is assigned to each sub-pixel of the display device in the one-to-one manner, the step SS3 further comprises: at M time-points of a time-period, the control device drives the deflecting device to deflect corresponding light-distribution zone of each sub-pixel to M positions sequentially, for presenting M corresponding sub-pixel-viewing-zones of each sub-pixel, where M≥2;

wherein, a group of pixels work as M different pixel groups corresponding to the M states of the deflecting device, respectively;

or, a group of sub-pixels work as M different sub-pixel groups corresponding to the M states of the deflecting device, respectively.

Preferably, adjacent pixels or sub-pixels are designed with different orthogonal characteristics;

wherein, each pixel or each sub-pixel only emits light of corresponding orthogonal characteristics, and each modulating element is endowed with orthogonal characteristics same to that of the corresponding pixel or sub-pixel for blocking light of non-corresponding orthogonal characteristics.

Preferably, each pixel or each sub-pixel of the display device is with an incident backlight of an asymmetric divergence angle or an asymmetric convergence angle, which leads an asymmetric light-distribution zone of beam projected by the pixel or sub-pixel.

Compared with existing glasses-free light-field display, the merits of the present invention are listed as follow.

In this patent application, the viewing zones of two-dimensional images are designed with a dense arrangement along the second direction but a sparse arrangement along the first direction. Coincidence with the structure property of a viewer's two pupils, which is that two pupils occupy a larger region along the first direction but a small region along the second direction, the proposed design strategy reduces the number of needed two-dimensional images for multi-view-one-eye display greatly. In order to project an asymmetric light-distribution zone along the corresponding projection direction, a modulating element is assigned to a pixel or a sub-pixel correspondingly, making the modulating more flexibly.

### BRIEF DESCRIPTION OF DRAWINGS

FIG. 1 shows an adoptable periodic structure of the modulating device in the comparative patent for asymmetric viewing zones.

FIG. 2 shows a pixel and its corresponding asymmetric pixel-viewing-zone.

FIG. 3 is a schematic diagram showing how asymmetric pixel-viewing-zones get presented.

FIG. 4 shows an arrangement example of the viewing zones along the second direction.

FIG. 5 shows a light intensity distribution corresponding to different viewing zones along the second direction.

FIG. 6 shows a design example I of the viewing zones along the first direction.

FIG. 7 shows another position relation between the pupils and the viewing zones along the first direction.

FIG. 8 shows a design example II of the viewing zones along the first direction.

FIG. 9 shows the pixel-viewing-zones corresponding to a same pixel with backlights along different directions.

FIG. 10 shows an arrangement example of the viewing zones with backlights along different directions.

FIG. 11 shows another arrangement example of the viewing zones with backlights along different directions.

FIG. 12 shows the deflected pixel-viewing-zones corresponding to a same pixel when a deflecting device is employed.

FIG. 13 shows an example of the misaligned pixel-viewing-zones corresponding to a pixel group.

FIG. 14 shows the divergent angle of the backlight for a pixel.

FIG. 15 is a compound modulating device.

FIG. 16 shows adjacent pixel/modulating structures with different orthogonal characteristics of linear polarizations.

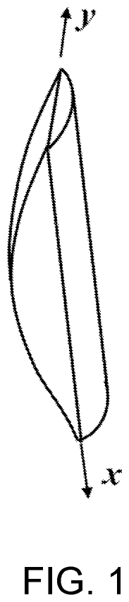

### DETAILED DESCRIPTION

The present invention will be further described in detail below in conjunction with the drawings and specific embodiments. The accompanying drawings are only for illustrative purposes and cannot be understood as a limitation of the patent; in order to better illustrate the embodiment, some parts of the accompanying drawings may be omitted, enlarged or reduced, and do not represent the size of the actual product; It is understandable for the personnel that some well-known structures in the drawings and their descriptions may be omitted.

### Embodiment

An optical system employed by the proposed glasses-free light-field display method includes a display device 10, a modulating device 20, and a control device 30 which is with a signal connection to the display device 10 or/and the modulating device 20. The display device 10 consists of pixels or sub-pixels, the modulating device 20 includes multiple modulating elements. The modulating elements correspond to the pixels or sub-pixels of the display device 10 in a one-to-one manner. A modulating element modulates the beam outgoing from or incident onto the corresponding pixel or sub-pixel, such that the corresponding pixel or the corresponding sub-pixel projects a beam with an asymmetric projection angle. The asymmetric projection angle results in an asymmetric light-distribution zone of the light with an intensity larger than 50% of the maximum value on an observing plane. This kind of asymmetric light-distribution zone is designed to have a size larger than Dₚ and smaller than Dₚₘ along a first direction, and smaller than Dₚ along a second direction. Here, Dₚ denotes a diameter of a pupil 60 and Dₚₘ means a minimum distance between two pupils of a viewer. The first direction is along the line connecting two pupils of a viewer, and the second direction is perpendicular to or approximately perpendicular to the first direction. An asymmetric light-distribution zone is named as a pixel-viewing-zone or a sub-pixel-viewing-zone of the corresponding pixel or the corresponding sub-pixel. In the following description, a pixel is taken as a basic display element, and pixel-viewing-zones are exampled for explaining the glasses-free light-field display method. The following process is also applicable to the case when a sub-pixel is taken as a basic display element.

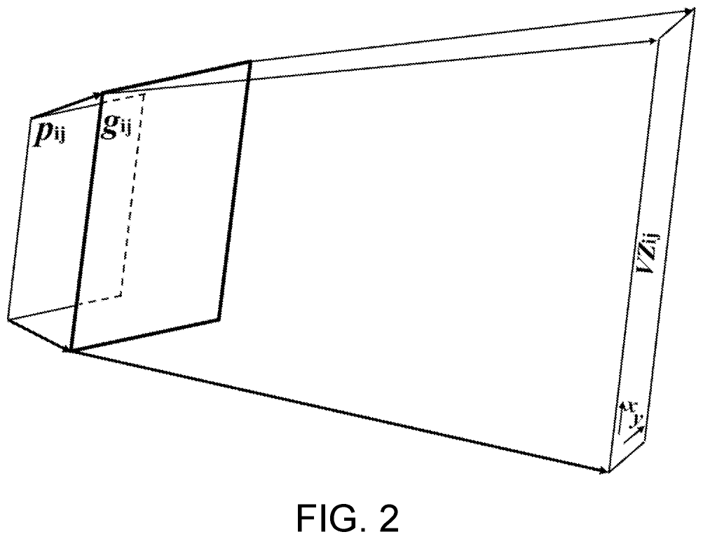

When a pixel-viewing-zone intersects with a pupil, the corresponding pixel will get visible by the eye containing this pupil. As shown in FIG. 2, the light from a pixel pᵢⱼ of the display device 10 is modulated by the corresponding modulation element gᵢⱼ, to project the corresponding pixel-viewing-zone VZᵢⱼ onto an observing plane S_{ob}. Here, the observing plane S_{ob} takes the xy plane. For any point of this pixel-viewing-zone VZᵢⱼ, the light from corresponding pixel pᵢⱼ is with a light intensity always larger than 50% of the maximum value. Here, the maximum value means the maximum light intensity on the observing plane projected by a corresponding pixel. Along the first direction, which is shown as x direction, the size of the pixel viewing zone VZᵢⱼ is designed to be larger than the viewer's pupil diameter Dₚ, but smaller than the minimum distance Dₚₘ between the viewer's pupils. Along the second direction y, the size of the pixel viewing zone VZᵢⱼ is smaller than the viewer's pupil. The first direction x and second direction y can be mutually perpendicular, or not. A modulating element also guides a pixel-viewing-zone to a corresponding position to guarantee that, for each pupil 60 on the observing plane S_{ob}, there exist at least two pixel groups whose pixel-viewing-zones all intersect with this pupil. The pixel-viewing-zones of a pixel group include pixel-viewing-zones being corresponded by each pixel of this pixel group, and they combine together into the viewing zone of this pixel group. The pixels of a pixel group are arranged throughout the display device 10. A two-dimensional image displayed by a pixel group will get visible by an eye, when the pupil 60 of this eye intersects with all the pixel-viewing-zones of the pixel group.

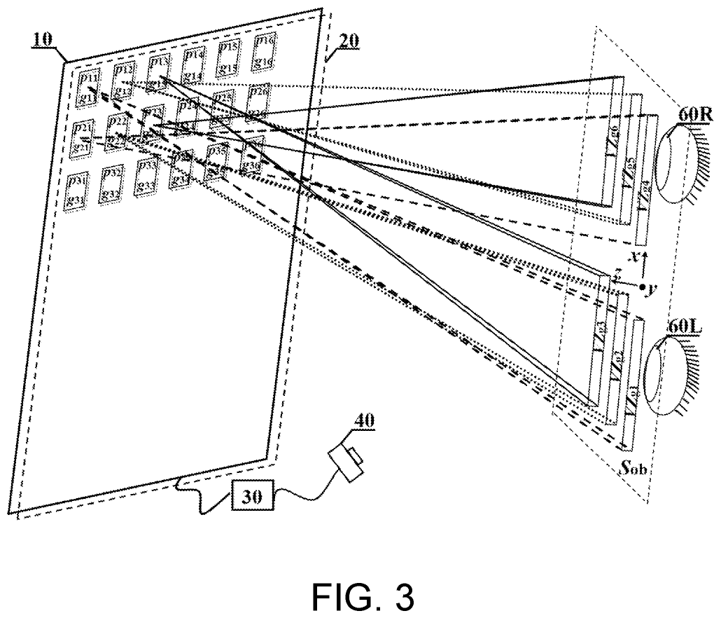

As shown in FIG. 3, the light from pH is modulated by modulating element g₁₁, and is guided to the corresponding pixel-viewing-zone VZ_{g1}; the light from p₁₂ is modulated by modulating element g₁₂, and is guided to the corresponding pixel-viewing-zone VZ_{g5}; the light from p₁₃ is modulated by modulating element g₁₃, and is guided to the corresponding pixel-viewing-zone VZ_{g3}; the light from p₂₁ is modulated by modulating element g₂₁, and is guided to the corresponding pixel-viewing-zone VZ_{g4}; the light from p₂₂ is modulated by modulating element g₂₂, and is guided to the corresponding pixel-viewing-zone VZ_{g2}; the light from p₂₃ is modulated by modulating element g₂₃, and is guided to the corresponding pixel-viewing-zone VZ_{g6}. The pixels of the display device 10 are divided into different groups. FIG. 3 takes 6 pixel groups as an example. Pixels p₁₁, p₁₄, p₁₇, . . . , p₃₁, p₃₄, p₃₇, . . . , p₅₁, p₅₄, p₅₇, . . . constitute a pixel group 1; pixel-viewing-zones corresponding to all these pixels overlap into the pixel-viewing-zone VZ_{g1}, that is to say, the pixel-viewing-zone VZ_{g1} functions as the viewing zone VZ_{g1} of the pixel group 1. Pixels p₂₂, p₂₅, p₂₈, . . . , p₄₂, p₄₅, p₄₈, . . . , p₆₂, p₆₅, p₆₈, . . . constitute a pixel group 2; pixel-viewing-zones corresponding to all these pixels overlap into the pixel-viewing-zone VZ_{g2}, that is to say, the pixel-viewing-zone VZ_{g2} functions as the viewing zone VZ_{g2} of the pixel group 2. Pixels p₁₃, p₁₆, p₁₉, . . . , p₃₃, p₃₆, p₃₉, . . . , p₅₃, p₅₆, p₅₉, . . . constitute a pixel group 3; pixel-viewing-zones corresponding to all these pixels overlap into the pixel-viewing-zone VZ_{g3}, that is to say, the pixel-viewing-zone VZ_{g3} functions as the viewing zone VZ_{g3} of the pixel group 3. Pixels p₂₁, p₂₄, p₂₇, . . . , p₄₁, p₄₄, p₄₇, . . . , p₆₁, p₆₄, p₆₇, . . . constitute a pixel group 4; pixel-viewing-zones corresponding to all these pixels overlap into the pixel-viewing-zone VZ_{g4}, that is to say, the pixel-viewing-zone VZ_{g4} functions as the viewing zone VZ_{g4} of the pixel group 4. Pixels p₁₂, p₁₅, p₁₈, . . . , p₃₂, p₃₅, p₃₈, . . . , p₅₂, p₅₅, p₅₈, constitute a pixel group 5; pixel-viewing-zones corresponding to all these pixels overlap into the pixel-viewing-zone VZ_{g}s, that is to say, the pixel-viewing-zone VZ_{g}s functions as the viewing zone VZ_{g}s of the pixel group 5. Pixels p₂₃, p₂₆, p₂₉, . . . , p₄₃, p₄₆, p₄₉, . . . , p₆₃, p₆₆, p₆₉, constitute a pixel group 6; pixel-viewing-zones corresponding to all these pixels overlap into the pixel-viewing-zone VZ_{g6}, that is to say, the pixel-viewing-zone VZ_{g6} functions as the viewing zone VZ_{g6} of the pixel group 6.

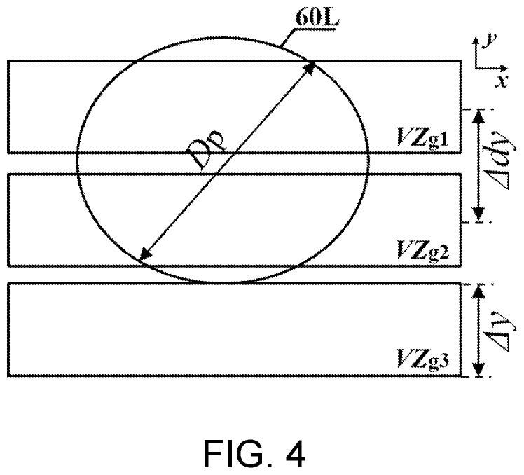

All the pixel-viewing-zones are with a size Δy<Dₚ along the second direction y, and with a size Dₚ<Δx<Dₚₘ along the first direction x. Two pupils 60L and 60R of a viewer locate approximately along the first direction x. In FIG. 3, the viewing zones VZ_{g1}, VZ_{g2}, VZ_{g3} are shown, corresponding to the viewer's left pupil 60L, and the viewing zones VZg4, VZg5, and VZg6 are shown, corresponding to the viewer's right pupil 60R. Specifically, taking the left pupil 60L and the corresponding view zones VZ_{g1}, VZ_{g2}, VZ_{g3} as example, as shown in FIG. 4. The left pupil 60L on the observing plane S_{ob} can see two two-dimensional images displayed by corresponding two pixel groups through adjacent viewing zones VZ_{g1} and VZ_{g2}, under the premise that the viewing-zone interval Δdy along the second direction y is smaller than Dₚ. Under the control of the control device 30, when any pixel gets refreshed by the projection information of a target object along the beam projected by this pixel, multi-view-one-eye display gets implemented. With smaller Δd_{y}, more two-dimensional images from more pixel groups will be perceived by each pupil. For an asymmetric pixel-viewing-zone, the light projected by a corresponding pixel has an obvious diverging angle, especially along the first direction. A pupil tracking unit 40 can be introduced to determine the real-time positions of the viewer's pupils. The information loaded on a pixel takes the projection information along a light ray coming from this pixel and reaching into the pupil. A modulating element can be a nanoimprinted grating, or a holographic grating, or a meta surface structure, or other structures, as long as these structures can realize the projection of an asymmetric light-distribution zone of the light from a pixel.

In FIG. 4, the pupil 60 locates on the observing plane S_{ob}. In fact, the pupil 60 can also deviate from the observing plane S_{ob} by a certain distance under the premise that, passing through a displayed object point, at least two beams from different pixels reach to the pupil 60.

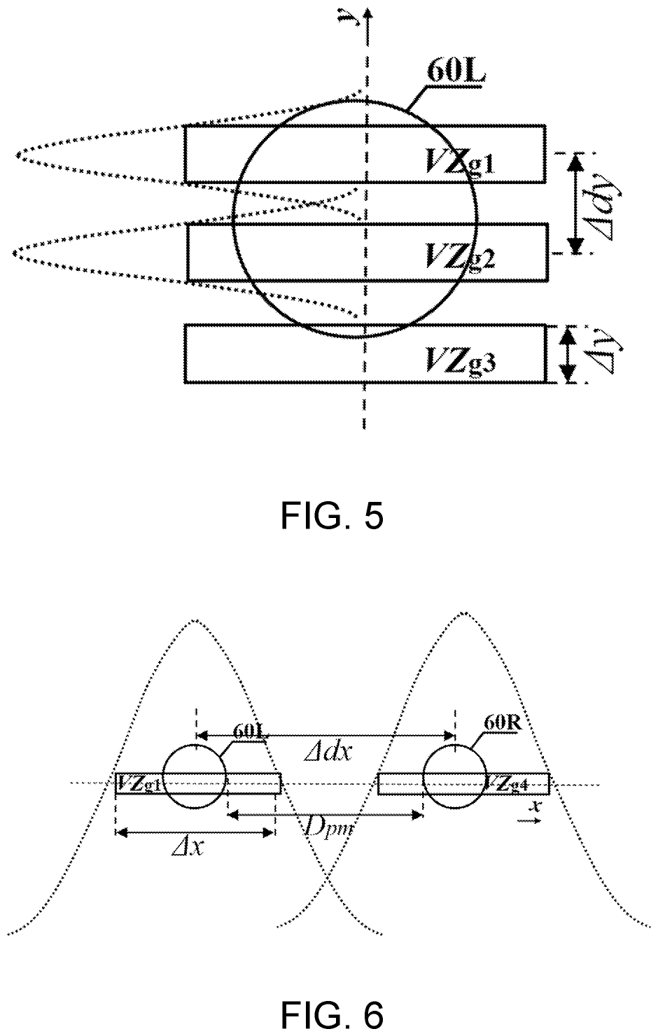

Along the second direction, the light intensity of two beams projected by two pixels of adjacent pixel groups is shown in FIG. 5. Obviously, along the second direction (y direction), smaller Δy is preferred for achieving smaller crosstalk between adjacent viewing zones. Here, Δy is the size of a viewing zone along the second direction.

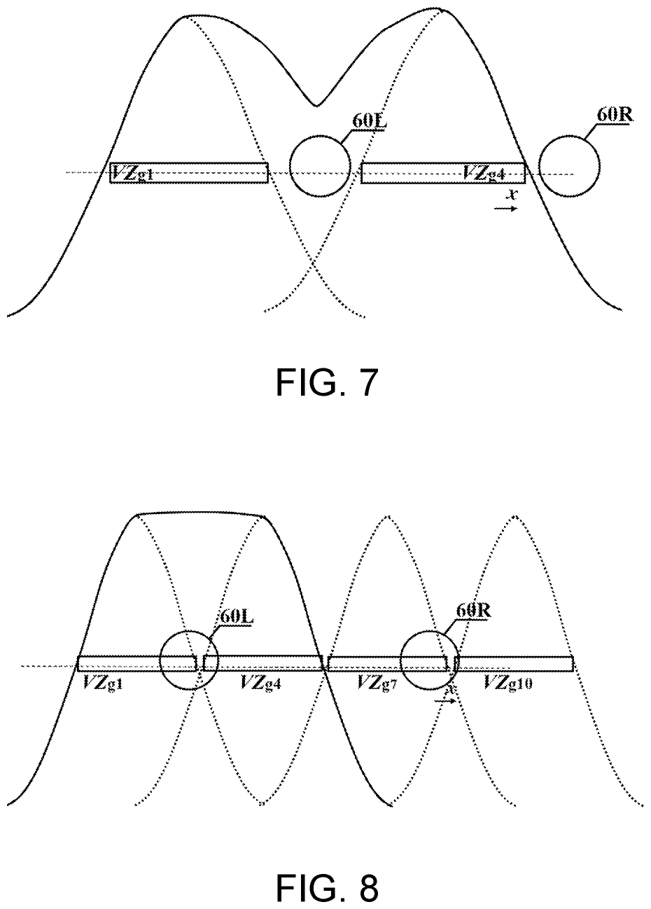

FIG. 6 shows the light intensity distribution of two pixels of adjacent two pixel groups along the first direction (x direction) by dotted curves. The two beams are set reaching to two pupils of a viewer in FIG. 6, respectively. Adjacent two pixel groups have a viewing-zone interval of Δdx. A viewing-zone size along the first direction is denoted by Δx. The value of Δx is often set not larger than that of Δdx. The VZ_{g1} and VZ_{g4} are the viewing zones corresponding to said two pixels, and they are intersected with two pupils of a viewer, respectively. The value of Δx is set smaller than Dₚₘ. When the pupils move to the positions shown in FIG. 7, a pupil misses the viewing zones. Taking the left pupil 60L as example, it does not intersect with the viewing zone VZ_{g1} nor the viewing zone VZ_{g4}, but intersect with regions between these two viewing zones and can perceive light from corresponding pixel groups through viewing zones VZ_{g1} and VZ_{g4}. This is because lights from these two pixels groups reach to these regions, also with an intensity not larger than 50% of the maximum value. That is to say, for the left pupil 60L shown in FIG. 7, if the pixel groups corresponding to the viewing zones VZ_{g1} and VZ_{g4} get refreshed by perspective views for the left pupil 60L, the display message perceived by the left pupil 60L is correct. The solid curve shown in FIG. 7 shows the superimposed light intensity of two beams from the viewing zones VZ_{g1} and VZ_{g4}, respectively. However, the right pupil 60R will also perceive the light through the viewing zones VZ_{g4}, which carries the perspective view converging to left pupil 60L and becomes crosstalk for the right pupil 60R (the crosstalk between two pupils). Reducing the value of Δdx will reduce this kind of crosstalk. As shown in FIG. 8, the Δdx is decreased to about a half of Dₚₘ. Under this condition, even when a pupil locates between two adjacent viewing zones along the first direction as shown by FIG. 8, the light from pixel groups for the left pupil 60L will not reach to the right pupil 60R, or will reach to the right pupil 60R at a very low intensity, and vice versa. Along the first direction, smaller Δdx and Δx are preferred for crosstalk suppression. But too small Δdx will increase the number of needed viewing zones. When a pupil locates between two viewing zones along the first direction, each pixel corresponding to these two viewing zones gets refreshed by projection information along a light ray coming from this pixel and reaching to this pupil. In this process, a pupil tracking unit 40 is often necessary for detecting the real-time positions of the pupils.

In above FIG. 2 and FIG. 3, a modulating element is designed to modulate the light from the corresponding pixel. Actually, a modulating element can also be designed to modulate the light incident onto the corresponding pixel when a display device 10 with backlits is adopted.

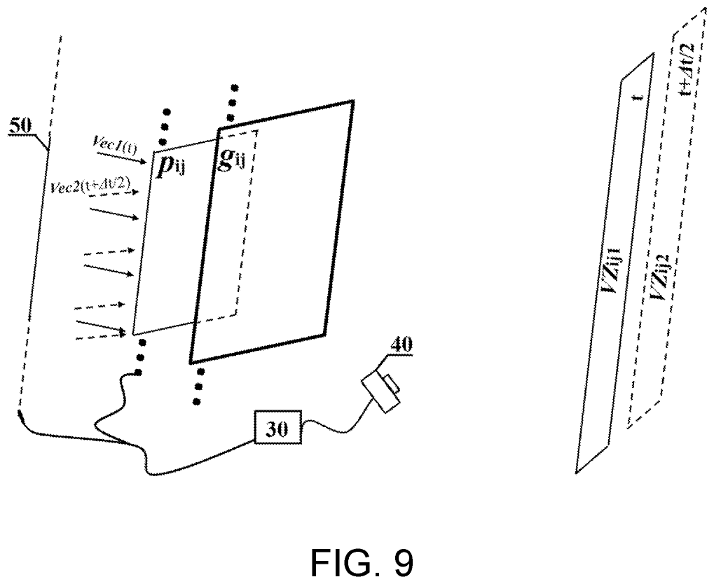

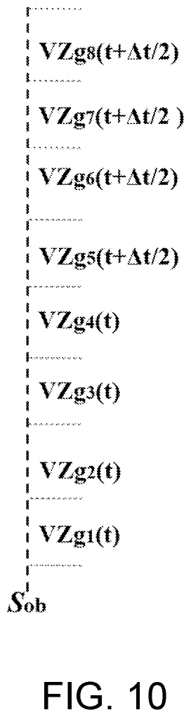

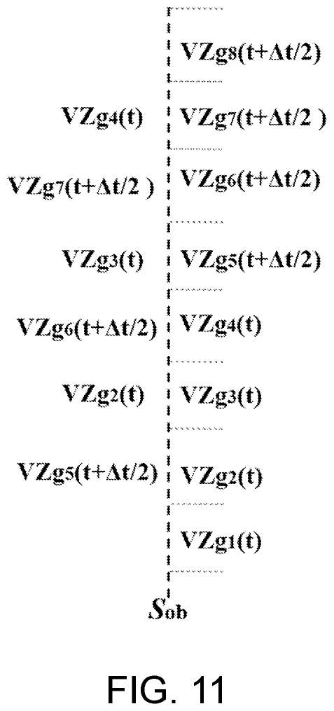

In the above embodiments, pixels of the display device 10 are defined into different pixel groups based on spatial multiplexing. Furthermore, time multiplexing can be introduced for presenting more pixel groups. In FIG. 9, a directional backlight structure 50 is added. Under the control of the control device 30, the directional backlight structure 50 can project backlights to the display device 10 along M≥2 directions. FIG. 9 takes backlights along M=2 different direction as example. At M=2 time-points t and t+Δt/2 of each time-period t˜t+Δt, the control device 30 drives the directional backlight structure 50 to project two parallel backlight along directions Vec1 and Vec2, respectively. Thus, at two time-points of each time period, the light from a pixel pᵢⱼ is modulated by the corresponding modulating element gᵢⱼ, and two pixel-viewing-zones VZᵢⱼ₁ and VZᵢⱼ₂ get presented. This is applicable to all pixels. For a group of pixels, there will be M=2 asynchronous viewing zones. A group of pixels bearing M asynchronous viewing zones is taken equivalently as M different pixel groups in this patent application, in accordance with their M different backlights. Thus, the number of viewing zones that can be presented gets increased by (M−1)-fold (i.e., the number of viewing zones that can be presented will have an M-fold increase), as exampled by FIG. 10, where 8 viewing zones get presented at M=2. These viewing zones can also be arranged as shown in FIG. 11.

The pupil tracking unit 40 can work together with the directional backlight structure 50. Under this condition, according to the real-time positions of the pupils, only 1≤M1<M backlight(s) is(are) activated in each time period, under the premise that the viewing zones corresponding to the activated backlight(s) are enough for multi-view-one-eye display.

The directions Vec1 and Vec2 shown in FIG. 9 are different along the second direction (y direction), and they can also be designed different along the first direction, or even different along other directions. FIG. 9 and FIG. 10 take M=2 as example. Of course, M can also take other values.

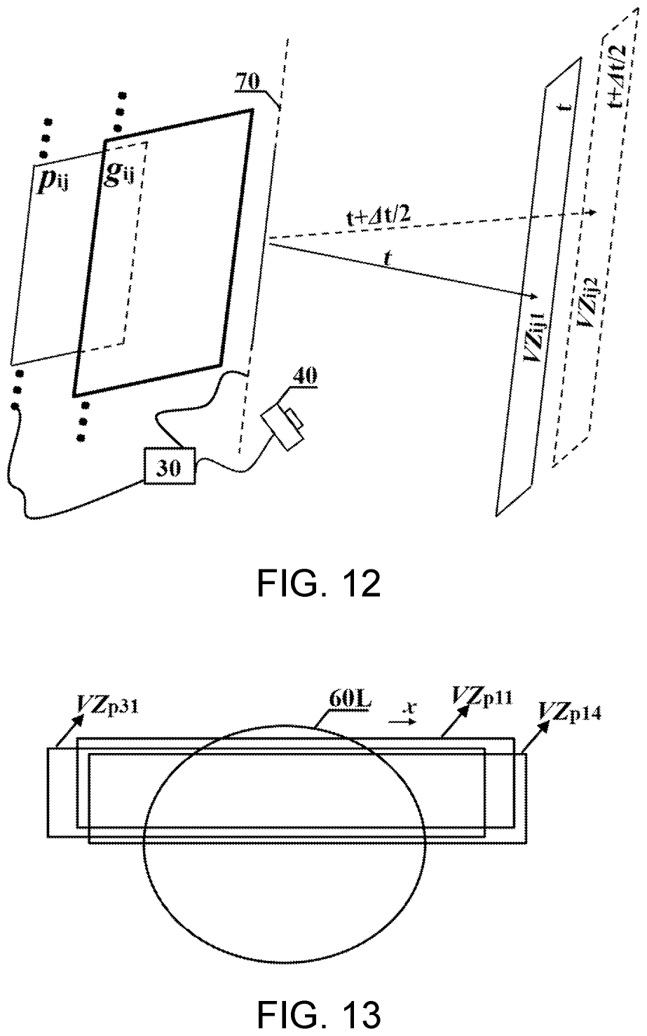

Time multiplexing can also get implemented by a deflecting device 70, which is able to deflect the beams outgoing from or incident onto the display device 10 under the control of said control device 30. As shown in FIG. 12, the deflecting device 70 can deflect the modulated beam from a pixel along M≥2 directions. FIG. 12 takes M=2 as example. At M=2 time-points t and t+Δt/2 of each time-period t˜t+Δt, the control device 30 drives the deflecting device 70 to deflect modulated beam from the pixel pᵢⱼ and the modulating element gᵢⱼ to two pixel-viewing-zones VZᵢⱼ₁ and VZᵢⱼ₂. This is applicable to all pixels. For a group of pixels, there will be M=2 asynchronous viewing zones. Similarly, a group of pixels bearing M asynchronous viewing zones is taken equivalently as M different pixel groups, in accordance with the M different states of the deflecting device 70. Thus, the number of viewing zones that can be presented gets increased by (M−1)-fold, i.e., the number of viewing zones that can be presented will have an M-fold increase. The deflecting device 70 can work together with a pupil tracking unit 40. Under this condition, according to the real-time positions of the pupils, only 1≤M1<M states of the deflecting device 70 is or are activated in each time period, under the premise that the viewing zones corresponding to activated states of the deflecting device 70 are enough for multi-view-one-eye display. In FIG. 12, the deflecting device 70 is placed behind the modulating device 20. It can also locate between the display device 10 and the modulating device 20, or in front of the display device 10.

In above embodiments, the pixel-viewing-zones corresponding to a pixel group overlap into a viewing zone of this pixel group. In fact, the pixel-viewing-zones corresponding to a pixel group can also be misaligned arranged. As exampled by FIG. 13, the pixel-viewing-zones VZₚ₁₁, VZₚ₁₄, VZₚ₃₁, which correspond to the pixels p₁₁, p₁₄, and p₃₁ of a same pixel group shown in FIG. 3, are misaligned arranged. For clarity of illustration, only three pixel-viewing-zones corresponding to partial pixels of a pixel group are shown in FIG. 13. In this case, for a pixel group, all related pixel-viewing-zones together function as the corresponding viewing zone. When all the pixel-viewing-zones of a viewing zone intersect with a pupil, the whole two-dimensional image displayed by a corresponding pixel group gets visible.

In above embodiments, the function of a modulating element can get implemented by all kinds of possible optical structure, such as nanoimprinted grating, or a holographic grating, or a metasurface structure. These optical structures are often with a chromatic dispersion. In this patent application, a modulating element can be designed consisting of different sub-modulating elements, with different sub-modulating elements being attached to different sub-pixels. Thus, light from a sub-pixel will be modulated by a corresponding sub-modulation element for a chromatic-dispersion-free display. Furthermore, a sub-pixel can be taken as the basic display element, and modulating elements of the modulating device 20 are attached to sub-pixels of the display device 10 in a one-to-one manner. More than one images projected by different sub-pixel groups should be projected to each pupil of the viewer for multi-view-one-eye display. Under this condition, passing through a displayed point, beams of different colors are preferred to be perceived by a pupil for a perfect color display. For example, with a RGB display device 10, it is preferred that beams from three monochrome sub-pixel groups of different colors are perceived by a pupil.

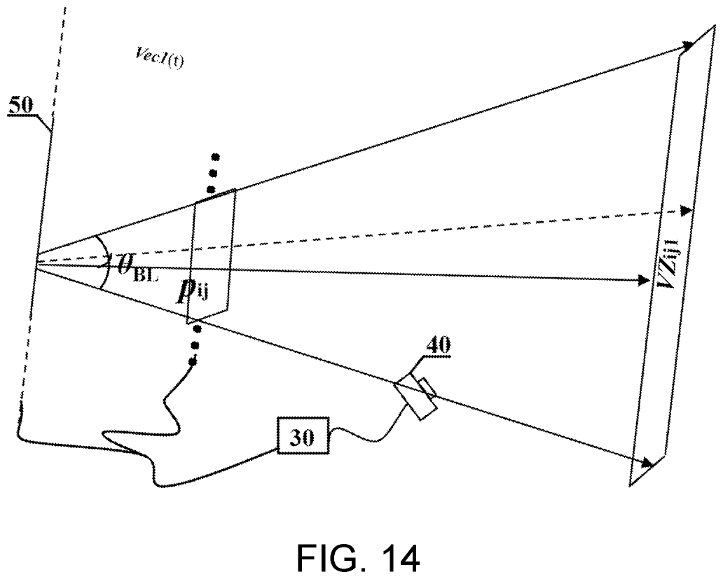

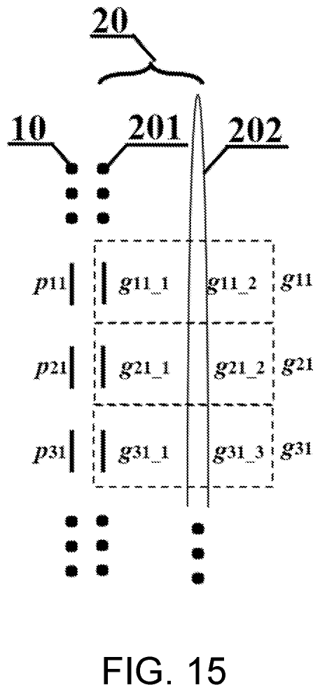

The directional backlight structure 50 can take an optical structure existing now or to appear in the future, as long as it can project backlights along different directions. For example, “the backlight-source assembly 103” of the United State invention patent titled “A display module with a divergence angle of an outgoing beam constrained again by a corresponding deflection aperture (Application No. US2022229308 A1. Publication Date Jul. 21, 2022)” which “can project backlights along different directions”, or the “back unit” of the article “LARGE REAL-TIME HOLOGRAPHIC 3D DISPLAYS: ENABLING COMPONENTS AND RESULTS (No. 13 of Vol. 56)” published in Applied Optics, can function as a directional backlight structure 50. Furthermore, the incident light onto a pixel or a sub-pixel can be designed with an asymmetric divergence angle or an asymmetric convergence angle, such as the asymmetric divergence angle θ_{BL} for the pixel pᵢⱼ shown in FIG. 14. Here, θ_{BL} is a solid angle. The θ_{BL} results in an asymmetric light-distribution zone of beam projected by the pixel pip. Under this condition, the corresponding modulating element gᵢⱼ can get free from the function of modulating the projection angle. That is to say, the asymmetric divergence angle or an asymmetric convergence angle of the backlight can replace the modulation function on the projection angle of the modulating element. Of course, the designing of an asymmetric divergence angle or an asymmetric convergence angle of the backlight and the modulating element can modulate the projection angle of a beam from each pixel or sub-pixel jointly. Incident lights with corresponding asymmetric divergence angle or corresponding asymmetric convergence angle for all pixels or sub-pixels work as a backlight for the whole display device 10. The directional backlight structure 50 can also project such backlight along different directions at different time-points of a time period.

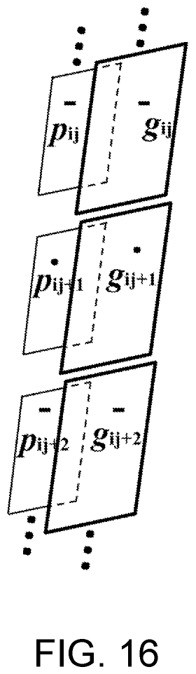

The modulating device 20 can also be some compound structures, such as a combination of a microstructure array 201 and a lens 202 shown in FIG. 15. Under this condition, a modulating element is a combination of a microstructure array 201 and a corresponding segment of the lens 202. For example, a microstructure g_{21_1} and a segment of the lens g_{21_2} together function as a modulating element g₂₁ in FIG. 15.

This patent application is based on the physiological feature of a viewer that the distance between two pupils of a viewer is much larger than the pupil diameter Dₚ. Consistent with this physiological feature, asymmetric viewing zones arranged densely along the first direction and sparsely along the second direction make glasses-free multi-view-one-eye display on existing display device hopeful, which decreases the number of needed viewing zone greatly.

There is another kind of crosstalk between adjacent pixel-modulating element structures, or adjacent sub-pixel-modulating element structures. Here, a pixel-modulating element structure is constructed by a pixel and corresponding modulating element, a sub-pixel-modulating element structure is constructed by a sub-pixel and corresponding modulating element. Such kind of crosstalk comes from the light which comes from a pixel or a sub-pixel but reaches to non-corresponding modulating element. An orthogonal characteristics design can suppress this kind of crosstalk. Adjacent pixels of sub-pixels of the display device 10 are designed with different orthogonal characteristics. That is to say, a pixel or a sub-pixel only emits light of corresponding orthogonal characteristics. Each modulating element is endowed with orthogonal characteristics same to that of corresponding pixel or sub-pixel for blocking light of non-corresponding orthogonal characteristics. Concretely, FIG. 16 takes adjacent two pixels having different orthogonal characteristics as example, and linear polarizations with mutual perpendicular polarizing directions function as the two orthogonal characteristics, which are denoted by “●” and “−” respectively. For simplicity, only three adjacent pixels pᵢⱼ, pᵢⱼ₊₁, and pᵢⱼ₊₂ are show in FIG. 16. Among them, pixels pᵢⱼ, and pᵢⱼ₊₂ emit “−” light, and pixel pᵢⱼ₊₁ emits “●” light. Modulating element gᵢⱼ, and gᵢⱼ₊₂ allow “−” light passing through, but block “●” light; modulating element gᵢⱼ₊₁ allows “●” light passing through, but blocks “−” light. Thus, the crosstalk between adjacent sub-pixel/modulating element structures gets suppressed. This is applicable to sub-pixel/modulating element structures arranged in two-dimensional surface. The orthogonal characteristics can take other characteristics, such as two circular polarizations of left circular polarization and right circular polarization, or timing characteristics being activated at different time-points, or combination of linear polarizations and timing characteristics, or combination of circular polarizations and timing characteristics.

Above only are the preferred embodiments of the present invention, but the design concept of the present invention is not limited to these. Any non-substantial modification made to the present invention using this concept, for example, only adopting a new optical structure as the modulating element, but implementing the display according to the method described in this patent application, also fall within the protection scope of the present invention. The display device can be with flat surface or a curved surface, can be all kinds of display apparatuses, such a OLED display screen, LED display screen, liquid crystal screen, Laser Beam Scanning (LBS), Digital Light Processing, etc.

What is claimed is:

1. A glasses-free light-field display method based on asymmetric light distribution of a projecting beam, wherein:
an optical system employed by the glasses-free light-field display method comprises a display device, a modulating device, and a control device connected to the display device, wherein the display device comprises a plurality of pixels or sub-pixels, the modulating device comprises multiple modulating elements which correspond to the pixels or sub-pixels of the display device in a one-to-one manner;
when each modulating element of the modulating device is assigned to each pixel of the display device in a one-to-one manner, the glasses-free light-field display method comprises following steps:
S1: each modulating element modulates a beam outgoing from or incident onto a corresponding pixel, such that the corresponding pixel projects a beam with an asymmetric projection angle, and the asymmetric projection angle results in an asymmetric light-distribution zone of light with an intensity larger than 50% of a maximum value on an observing plane;
wherein, the asymmetric light-distribution zone which is taken as a pixel-viewing-zone of the corresponding pixel has a size larger than Dₚ and smaller than Dₚₘ along a first direction and smaller than Dₚ along a second direction, with Dₚ being a diameter of a pupil and Dₚₘ being a minimum distance between two pupils of a viewer;
S2: each modulating element modulates a projecting direction of the beam projected by the corresponding pixel, in order that all pixel-viewing-zones corresponding to at least two pixel groups intersect with the pupil on the observing plane;
wherein, pixels of each pixel group are arranged throughout the display device, and two pixel-viewing-zones corresponding to two pixels of different groups for a same pupil are set with a non-zero distance along the second direction;
S3: the control device refreshes each pixel by a corresponding light information, which is a projection information of a target object along the beam projected by the pixel;
or, when each modulating element of the modulating device is assigned to each sub-pixel of the display device in a one-to-one manner, the glasses-free light-field display comprises following steps:
SS1: each modulating element modulates a beam outgoing from or incident onto a corresponding sub-pixel, such that the corresponding sub-pixel projects a beam with an asymmetric projection angle, and the asymmetric projection angle results in an asymmetric light-distribution zone of light with an intensity larger than 50% of the maximum value on an observing plane;
wherein, the asymmetric light-distribution zone which is taken as a sub-pixel-viewing-zone of the corresponding sub-pixel has a size larger than Dₚ and smaller than Dₚₘ along a first direction and smaller than Dₚ along a second direction, with Dₚ being the diameter of a pupil and Dₚₘ being the minimum distance between two pupils of a viewer;
SS2: each modulating element modulates a projecting direction of the beam projected by the corresponding sub-pixel, in order that all sub-pixel-viewing-zones corresponding to at least two sub-pixel groups intersect with the pupil on the observing plane;
wherein, sub-pixels of each sub-pixel group are arranged throughout the display device, and two sub-pixel-viewing-zones corresponding to two sub-pixels of different groups for a same pupil are set with a non-zero distance along the second direction;
SS3: the control device refreshes each sub-pixel by a corresponding light information, which is a projection information of a target object along the beam projected by the sub-pixel.

2. The glasses-free light-field display method based on asymmetric light distribution of the projecting beam according to claim 1, wherein, when each modulating element of the modulating device is assigned to each pixel of the display device in the one-to-one manner, centers of all pixel-viewing-zones corresponding to a same pixel group overlap and an overlapping region of the sub-pixel-viewing-zones is taken as a viewing zone corresponding to the pixel group;
or when each modulating element of the modulating device is assigned to each sub-pixel of the display device in the one-to-one manner, centers of all sub-pixel-viewing-zones corresponding to a same sub-pixel group overlap and an overlapping region of the sub-pixel-viewing-zones is taken as a viewing zone corresponding to the sub-pixel group.

3. The glasses-free light-field display method based on asymmetric light distribution of the projecting beam according to claim 1, wherein, the optical system further comprises a directional backlight structure capable of projecting backlights to the display device along different directions under control of the control device.

4. The glasses-free light-field display method based on asymmetric light distribution of the projecting beam according to claim 3, wherein, a backlight provides an incident light to a pixel or a sub-pixel at an asymmetric divergence angle or an asymmetric convergence angle which makes the beam projected by the pixel or sub-pixel be with the asymmetric light-distribution zone of light with an intensity larger than 50% of the maximum value on an observing plane.

5. The glasses-free light-field display method based on asymmetric light distribution of the projecting beam according to claim 3, wherein the optical system comprises a pupil tracking unit connecting with the control device, to detect spatial positions of viewer's pupils;
wherein, when each modulating element of the modulating device is assigned to each pixel of the display device in the one-to-one manner, the step S3 further comprises: at a time-point, according to real-time positions of pupils detected by the pupil tracking unit, the control device drives the directional backlight structure to project a backlight along a corresponding direction, in order that pixel-viewing-zones corresponding to the at least two pixel groups intersect with the pupil on the observing plane;
or, when each modulating element of the modulating device is assigned to each sub-pixel of the display device in the one-to-one manner, the step SS3 further comprises: at a time-point, according to real-time positions of pupils detected by the pupil tracking unit, the control device drives the directional backlight structure to project the backlight along the corresponding direction, in order that sub-pixel-viewing-zones corresponding to the at least two sub-pixel groups intersect with the pupil on the observing plane.

6. The glasses-free light-field display method based on asymmetric light distribution of the projecting beam according to claim 3, wherein, when each modulating element of the modulating device is assigned to each pixel of the display device in the one-to-one manner, the step S3 further comprises: at M time-points of each time-period, the control device drives the directional backlight structure to project the backlight along M directions sequentially, for presenting M corresponding pixel-viewing-zones of each pixel, where M≥2;
or, when each modulating element of the modulating device is assigned to each sub-pixel of the display device in the one-to-one manner, the step SS3 further comprises: at M time-points of each time-period, the control device drives the directional backlight structure to project the backlight along M directions sequentially, for presenting M corresponding sub-pixel-viewing-zones of each sub-pixel, where M≥2;
wherein, a group of pixels work as M different pixel groups with backlights along different directions;
or, a group of sub-pixels work as M different sub-pixel groups with backlights along different directions.

7. The glasses-free light-field display method based on asymmetric light distribution of the projecting beam according to claim 1, wherein each modulating element of the modulating device is a nanoimprinted grating, or a holographic grating, or a meta surface structure.

8. The glasses-free light-field display method based on asymmetric light distribution of the projecting beam according to claim 1, wherein, when each modulating element of the modulating device is assigned to each pixel of the display device in the one-to-one manner, the pixel-viewing-zones corresponding to different pixels of a same pixel group are misaligned arranged.

9. The glasses-free light-field display method based on asymmetric light distribution of the projecting beam according to claim 1, wherein, when each modulating element of the modulating device is assigned to each sub-pixel of the display device in the one-to-one manner, the sub-pixel-viewing-zones corresponding to different sub-pixels of a same sub-pixel group are misaligned arranged.

10. The glasses-free light-field display method based on asymmetric light distribution of the projecting beam according to claim 1, wherein, the optical system further comprises a deflecting device which is capable of deflecting the beams outgoing from or incident onto the display device under control of the control device.

11. The glasses-free light-field display method based on asymmetric light distribution of the projecting beam according to claim 10, wherein, the optical system further comprises a pupil tracking unit connected with the control device, to detect spatial positions of viewer's pupils;
wherein, when each modulating element of the modulating device is assigned to each pixel of the display device in the one-to-one manner, the step S3 further comprises: at a time-point, according to real-time positions of pupils detected by the pupil tracking unit, the control device drives the deflecting device to deflect the pixel-viewing-zones correspondingly, in order that all pixel-viewing-zones corresponding to the at least two pixel groups intersect with the pupil on the observing plane synchronously;
or, when each modulating element of the modulating device is assigned to each sub-pixel of the display device in the one-to-one manner, the step SS3 further comprises: at a time-point, according to the real-time positions of pupils detected by the pupil tracking unit, the control device drives the deflecting device to deflect the sub-pixel-viewing-zones correspondingly, in order that all sub-pixel-viewing-zones corresponding to the at least two sub-pixel groups intersect with the pupil on the observing plane synchronously.

12. The glasses-free light-field display method based on asymmetric light distribution of the projecting beam according to claim 10, wherein, when each modulating element of the modulating device is assigned to each pixel of the display device in the one-to-one manner, the step S3 further comprises: at M time-points of a time-period, the control device drives the deflecting device to deflect corresponding light-distribution zone of each pixel to M positions sequentially, for presenting M corresponding pixel-viewing-zones of each pixel, where M≥2, or, when each modulating element of the modulating device is assigned to each sub-pixel of the display device in the one-to-one manner, the step SS3 further comprises: at M time-points of a time-period, the control device drives the deflecting device to deflect corresponding light-distribution zone of each sub-pixel to M positions sequentially, for presenting M corresponding sub-pixel-viewing-zones of each sub-pixel, where M≥2;
wherein, a group of pixels work as M different pixel groups corresponding to the M states of the deflecting device, respectively;
or, a group of sub-pixels work as M different sub-pixel groups corresponding to the M states of the deflecting device, respectively.

13. The glasses-free light-field display method based on asymmetric light distribution of the projecting beam according to claim 1, wherein, adjacent pixels or sub-pixels are designed with different orthogonal characteristics;
wherein, each pixel or each sub-pixel only emits light of corresponding orthogonal characteristics, and each modulating element is endowed with orthogonal characteristics same to that of the corresponding pixel or sub-pixel for blocking light of non-corresponding orthogonal characteristics.

14. The glasses-free light-field display method based on asymmetric light distribution of the projecting beam according to claim 1, wherein, each pixel or each sub-pixel of the display device is with an incident backlight of an asymmetric divergence angle or an asymmetric convergence angle, which leads to an asymmetric light-distribution zone of beam projected by the pixel or sub-pixel.
